(19) United States
(12) Patent Application Publication
(10) Pub. No.: US 2022/0351239 A1
(43) Pub. Date: Nov. 3, 2022

(54) MACHINE LEARNING BASED METHODS AND APPARATUS FOR AUTOMATICALLY GENERATING ITEM RANKINGS

(71) Applicant: Walmart Apollo, LLC, Bentonville, AR (US)

(72) Inventors: Rashad Mohamed Tawfik Rashad Eletreby, Lyndhurst, NJ (US); Cun Mu, Jersey City, NJ (US); Zhenrui Wang, Fremont, CA (US); Rajyashree Mukherjee, San Carlos, CA (US)

(21) Appl. No.: 17/246,179

(22) Filed: Apr. 30, 2021

(51) Int. Cl. G06Q 30/02; G06Q 30/06; G06N 20/00

(52) U.S. Cl. CPC G06Q 30/0246; G06Q 30/0201; G06Q 30/0633; G06N 20/00

(57) ABSTRACT

This application relates to apparatus and methods for training machine learning models, and applying trained machine learning models to generate item ranking values. In some examples, user session data for multiple users is received. Based on the user session data, user engagement data is generated characterizing engagements of corresponding items for a search query. Further, a number of examines is determined for each of the corresponding items. The user engagement data for each item is normalized based on the corresponding number of examines, and ranking data is generated based on the normalized user engagement data. The ranking data characterizes a ranking of at least a subset of the items. Further, a machine learning model is trained based on the ranking data. In some examples, the trained machine learning model is applied to a query to generate a ranking of items, and the ranking data is transmitted to a web server.

### TECHNICAL FIELD

The disclosure relates generally to machine learning processes and, more specifically, to training and applying machine learning processes to automatically rank items.

### BACKGROUND

At least some websites, such as retailer websites, allow a visitor to search for items. For example, the website may include a search bar that allows the visitor to enter search terms, such as one or more words, that the website uses to search for items. In response to the search terms, the website may display search results determined by a search algorithm, such as a machine learning model, implemented by the website. The search results may identify items that are offered for purchase by the retailer. These search results, however, can have drawbacks. For example, the search results may include items that are irrelevant to the person conducting the search query. In some cases, the search results may include items that do not correspond to the intent of the person conducting the search. In other examples, items that a person would be interested in may appear lower in the search results. As a result, the person conducting the search may need to spend time ignoring irrelevant search results before viewing relevant search results. For example, a website visitor conducting a search may need to peruse through many search result items before potentially locating an item they are interested in. In some cases, the person may decide to stop searching though the results to find a wanted item, and may make a purchase of the wanted item elsewhere. As such, there are opportunities to improve search results, such as those in response to a search query, provided to website visitors.

### SUMMARY

The embodiments described herein are directed to training machine learning models, and applying the trained machine learning models to generated features to rank items in response to, for example, a search query. The ranked items may be provided as search results to the search query. For example, a search request may be entered in a search bar of a website. In response, one or more trained machine learning models may be applied to the search query and attributes of one or more items to determine search results. For example, the trained machine learning models may generate a ranking of items that are provided as search results. The website may then display the determined search results. In some examples, higher ranked items are displayed before lower ranked items. For example, the search results may include a ranking of items, where higher ranked items (e.g., more relevant items) are ranked ahead of lower ranked items (e.g., less relevant items). The items may then be displayed in ranked order.

The embodiments may generate item engagement metrics based on historical user session data. The historical user session data may identify and characterize user browsing sessions of a website, such as a retailer's website, for example. The historical user session data may identify, as an example, one or more items viewed, items clicked, items added to an online shopping cart, and items purchased during a user session (e.g., user browsing session). The historical user session data may also identify, for example, one or more search queries provided by a user, search results displayed to the user in response to each search query, and one or more items viewed, items clicked, items added to an online shopping cart, and items purchased among the search results.

The embodiments may determine, for each of a plurality of the search queries, one or more item engagement metrics (e.g., stacked item engagement metrics), such as an order-through rate (OTR), an add-to-cart rate (ATR), or a click-through rate (CTR), based on the historical user session data. Further, the embodiments may determine a number of examines for each item (e.g., for each query, item pair), and may normalize the item engagement metrics based on the determined number of examines for the items. The embodiments may determine that an item has been examined when, for example, the user session data indicates the item was clicked. In some examples, the embodiments determine that a clicked item, and any items appearing before the clicked item on a search results page, were examined. The embodiments may generate query-item pair data that characterizes the normalized engagement metrics, for example. The embodiments may further adjust the normalized engagement metrics based on a beta distribution, such as one employing Beta random variables, for example.

Further, the embodiments may generate, for each of the search queries, an item ranking based on the adjusted and normalized engagement metrics. The embodiments may generate training labels based on the item rankings, and may train a machine learning model, such as one based on Gradient Boosted Trees or a neural network, with generated training features and the generated training labels. The training features may be generated, for example, based on the historical user session data. For example, the training features may include each of the plurality of search queries, and the one or more items viewed, items clicked, items added to an online shopping cart, and items purchased among search results provided to each search query.

Once trained, the machine learning model may be applied to a search query, such as one received in real time, to generate a ranking of items to the search query. The ranked items may then be displayed to a user, such as the user provided the search query. For example, item advertisements for the ranked items may be displayed, on a search results page, in order of the determined item ranking.

In some examples, user session data for a plurality of users is received. Based on the user session data, user engagement data is generated characterizing engagements of corresponding items for a search query. Further, a number of examines is determined for each of the corresponding items. The user engagement data for each of the items is normalized based on the corresponding number of examines, and ranking data is generated based on the normalized user engagement data. The user engagement data may be normalized using Beta random variables as described herein, for example. The ranking data characterizes a ranking of at least a subset of the items. A machine learning model is trained based on the ranking data. In some examples, the trained machine learning model is applied to a query to generate a ranking of items corresponding to the query. The ranking data may be transmitted to a web server for display of the items.

Thus, the embodiments may allow a customer to be presented with search results that are more relevant to a customer conducting the search. For example, the embodiments may allow a retailer to present more relevant search results to each customer. The embodiments may also allow a retailer to present items the customer may be interested in earlier in a search result listing. As a result, customer experience with a website may be improved. For example, the customer may more quickly locate an item of interest, which may save the customer time as well as encourage the customer to purchase the item. In addition, because a customer may now spend less time searching for an item, the customer may have additional time to consider additional items for purchase. In addition to or instead of these example advantages, persons of ordinary skill in the art would recognize and appreciate other advantages as well.

In accordance with various embodiments, exemplary systems may be implemented in any suitable hardware or hardware and software, such as in any suitable computing device. For example, in some embodiments, a computing device is configured to receive user session data for a plurality of users. The computing device is also configured to generate, based on the user session data, user engagement data characterizing engagements of one or more corresponding items for each of a plurality of queries. Further, the computing device is configured to determine, based on the user session data, a number of examines for each of the one or more corresponding items for each of the plurality of queries. The computing device is also configured to normalize the user engagement data for each of the one or more corresponding items of each of the plurality of queries based on the corresponding number of examines. The computing device is further configured to generate ranking data characterizing a ranking of at least a subset of the plurality of items based on the normalized user engagement data. The computing device is also configured to train a machine learning model based on the ranking data.

In some embodiments, a computing device is configured to receive a query for a user. The computing device is also configured to apply a trained machine learning model to the query to generate item ranking data characterizing a ranking of items. Further, the computing device is configured to transmit the ranking of items in response to the received query.

In some embodiments, a method is provided that includes receiving user session data for a plurality of users. The method also includes generating, based on the user session data, user engagement data characterizing engagements of one or more corresponding items for each of a plurality of queries. Further, the method includes determining, based on the user session data, a number of examines for each of the one or more corresponding items for each of the plurality of queries. The method also includes normalizing the user engagement data for each of the one or more corresponding items of each of the plurality of queries based on the corresponding number of examines. The method further includes generating ranking data characterizing a ranking of at least a subset of the plurality of items based on the normalized user engagement data. The method also includes training a machine learning model based on the ranking data.

In some embodiments, a method is provided that includes receiving a query for a user. The method also includes applying a trained machine learning model to the query to generate item ranking data characterizing a ranking of items. Further, the method includes transmitting the ranking of items in response to the received query.

In yet other embodiments, a non-transitory computer readable medium has instructions stored thereon, where the instructions, when executed by at least one processor, cause a computing device to perform operations that include receiving user session data for a plurality of users. The operations also include generating, based on the user session data, user engagement data characterizing engagements of one or more corresponding items for each of a plurality of queries. Further, the operations include determining, based on the user session data, a number of examines for each of the one or more corresponding items for each of the plurality of queries. The operations also include normalizing the user engagement data for each of the one or more corresponding items of each of the plurality of queries based on the corresponding number of examines. The operations further include generating ranking data characterizing a ranking of at least a subset of the plurality of items based on the normalized user engagement data. The operations also include training a machine learning model based on the ranking data.

In yet other embodiments, a non-transitory computer readable medium has instructions stored thereon, where the instructions, when executed by at least one processor, cause a computing device to perform operations that include receiving a query for a user. The operations also include applying a trained machine learning model to the query to generate item ranking data characterizing a ranking of items. Further, the operations includes transmitting the ranking of items in response to the received query.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item ranking system in accordance with some embodiments;

FIG. 2 is a block diagram of an item ranking computing device in accordance with some embodiments;

FIG. 3 is a block diagram illustrating examples of various portions of the item ranking system of FIG. 1 in accordance with some embodiments;

FIG. 4 is a block diagram illustrating examples of various portions of the item ranking computing device of FIG. 1 in accordance with some embodiments;

FIG. 5 is a flowchart of an example method that can be carried out by the item ranking system of FIG. 1 in accordance with some embodiments;

FIG. 6A is a flowchart of an example method that can be carried out by the item ranking system of FIG. 1 in accordance with some embodiments; and

FIG. 6B is a flowchart of an example method that can be carried out by the item ranking system of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

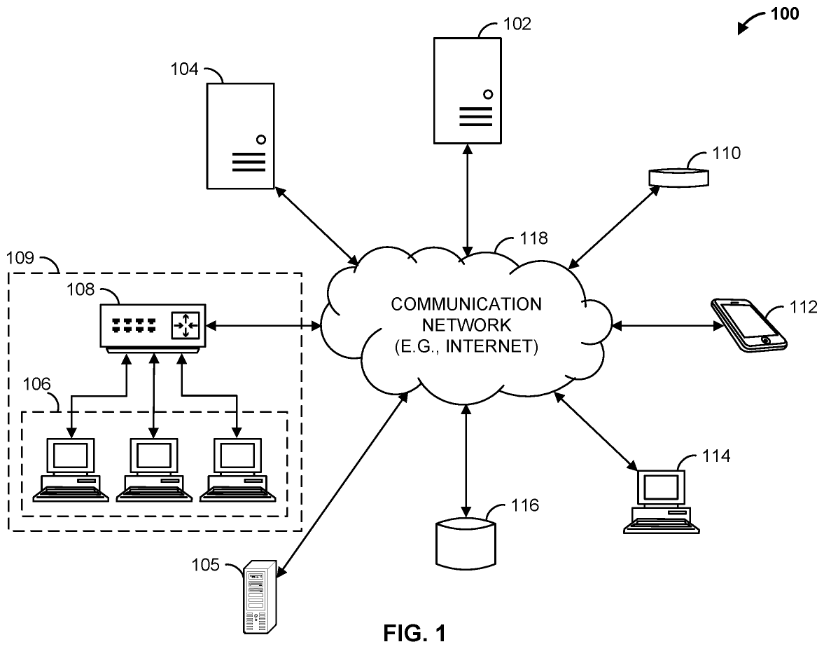

Turning to the drawings, FIG. 1 illustrates a block diagram of an item ranking system 100 that includes item ranking computing device 102 (e.g., a server, such as an application server), a web server 104, workstation(s) 106, database 116, an item recommendation system 105, and multiple customer computing devices 110, 112, 114 operatively coupled over network 118. Item ranking computing device 102, workstation(s) 106, server 104, item recommendation system 105, and multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, item ranking computing device 102 can be a computer, a workstation, a laptop, a server such as a cloud-based server, or any other suitable device. In some examples, each of multiple customer computing devices 110, 112, 114 can be a cellular phone, a smart phone, a tablet, a personal assistant device, a voice assistant device, a digital assistant, a laptop, a computer, or any other suitable device. In some examples, item ranking computing device 102 is operated by a retailer, and multiple customer computing devices 112, 114 are operated by customers of the retailer.

Although FIG. 1 illustrates three customer computing devices 110, 112, 114, item ranking system 100 can include any number of customer computing devices 110, 112, 114. Similarly, item ranking system 100 can include any number of workstation(s) 106, item ranking computing devices 102, web servers 104, item recommendation systems 105, and databases 116.

Workstation(s) 106 are operably coupled to communication network 118 via router (or switch) 108. Workstation(s) 106 and/or router 108 may be located at a store 109, for example. Workstation(s) 106 can communicate with item ranking computing device 102 over communication network 118. The workstation(s) 106 may send data to, and receive data from, item ranking computing device 102. For example, the workstation(s) 106 may transmit purchase data related to orders purchased by customers at store 109 to item ranking computing device 102. In some examples, item ranking computing device 102 may transmit, in response to received purchase data, an indication of one or more item advertisements to provide to a customer. For example, the item advertisements may be displayed on a receipt handed to the customer for the purchase order.

In some examples, web server 104 hosts one or more web pages, such as a retailer's website. The website may allow for the purchase of items. Web server 104 may transmit purchase data related to orders purchased on the website by customers to item ranking computing device 102. In some examples, web server 104 transmits user session data to item ranking computing device 102. The user session data identifies events associated with browsing sessions. Web server 104 may also transmit a search request to item ranking computing device 102. The search request may identify a search query provided by a customer. In response, to the search request, item ranking computing device 102 may transmit an indication of one or more items to advertisements to the purchasing customer, such as by displaying item advertisements for the items on the website. For example, the item advertisements may be displayed on a search results webpage in response to a search query entered by a customer.

First customer computing device 110, second customer computing device 112, and N^{th} customer computing device 114 may communicate with web server 104 over communication network 118. For example, each of multiple computing devices 110, 112, 114 may be operable to view, access, and interact with the website hosted by web server 104. In some examples, the website allows a customer to search for items via, for example, a search bar. A customer operating one of multiple computing devices 110, 112, 114 may access the website via an executed browsing application and perform a search for items on the website by entering in one or more terms into the search bar. In response, the website may return search results identifying one or more items. The website may further allow the customer to add one or more of the items received in the search results to an online shopping cart, and allow the customer to perform a “checkout” of the shopping cart to purchase the items.

Item ranking computing device 102 is operable to communicate with database 116 over communication network 118. For example, item ranking computing device 102 can store data to, and read data from, database 116. Database 116 can be a remote storage device, such as a cloud-based server, a disk (e.g., a hard disk), a memory device on another application server, a networked computer, or any other suitable remote storage. Although shown remote to item ranking computing device 102, in some examples, database 116 can be a local storage device, such as a hard drive, a non-volatile memory, or a USB stick. Item ranking computing device 102 may store purchase data received from store 109 and/or web server 104 in database 116. Item ranking computing device 102 may also store user session data identifying events associated with browsing sessions, such as when a customer browses a website hosted by web server 104. In some examples, database 116 stores one or more machine learning models that, when executed by item ranking computing device 102, allow item ranking computing device 102 to determine one or more search results, such as items, in response to a search query.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Item ranking computing device 102 can train machine learning models (e.g., algorithms) to generate ranking values that rank items for a given search query. A first item with a comparatively higher ranking than a second item may indicate that the first item is more relevant to a corresponding search query than the second item. Item ranking computing device 102 may apply the trained machine learning models to search queries to generate ranking values for items corresponding to each search query. Item advertisements may then be displayed for the ranked items. In some examples, item advertisements are displayed for the items in order of their corresponding rankings (e.g., an advertisement for a higher ranked item is displayed before an advertisement for a lower ranked item).

For example, web server 104 may provide a website that allows users to input search queries via, for example, a search bar. Web server 104 may transmit the search query to item ranking computing device 102 and, in response, item ranking computing device 102 may generate ranking values for one or more items based on applying a trained machine learning model to the search query.

In some examples, item ranking computing device 102 requests an initial set of items from a recommendation system, such as item recommendation system 105. Item recommendation system 105 may be a third-party server that provides item recommendations for a given search query. Item ranking computing device 102 may transmit the search request to item recommendation system 105 and, in response, receive data identifying one or more items. Item ranking computing device 102 may generate the ranking values for the items as described herein.

Item ranking computing device 102 may transmit the ranking values to web server 104. Web server 104 may display, on the website, item advertisements (e.g., digital advertisements) for the ranked items based on the received item rankings. For example, web server 104 may display, as a first search result, an item advertisement for the highest ranked item. Web server 104 may display as a second search result an advertisement for the next highest ranked item. The second search result may appear after the first search result, for example. Each item advertisement may include, for example, an image of the item, a price of the item, and an add-to-cart icon that facilitates the purchase of the item.

To train a machine learning model, item ranking computing device 102 may obtain, from database 116, historical user session data that identifies and characterizes item engagements and corresponding search queries. The historical user session data may be aggregated based on corresponding time periods, such as for a day, a month, a quarter, or a year. Moreover, the historical user session data may include user engagement data that identifies items a user has engaged (e.g., clicked, ordered, added to cart, etc.) after receiving search results for a search query the user provided via a website's search bar. For example, item ranking computing device 102 may determine, based on the user engagement data, an order-through rate (OTR), and add-to-cart rate (ATR), or a click-through rate (CTR) for each item-query pair. Item ranking computing device 102

Further, item ranking computing device 102 may determine, for each engaged item corresponding to a search query, item examination data identifying a number of examines based on the historical user session data. An item may be considered examined if a user engaged (e.g., clicked) an item advertisement for the item, or if the item appeared in a search result before another item in the search result that was engaged. For example, assume search results to a search query includes three item advertisements, namely, a first item advertisement, a second item advertisement, and a third item advertisement, displayed in this order. If a user clicks on, for example, the second item advertisement, items for both the first advertisement and the second advertisement may be considered examined. The item for the third advertisement would not be considered examined because the third advertisement does not appear before the second advertisement. In some examples, any item advertisement appearing on a same page (e.g., web page) as an engaged item (e.g., item advertised by second item advertisement) may be considered examined.

Item ranking computing device 102 may normalize portions of the user engagement data based on the corresponding item examination data. For example, item ranking computing device 102 may apply Beta random variables to automatically adjust (e.g., and normalize) the user engagement data based on the number of examines. Item ranking computing device 102 may generate an initial ranking of items for a search query based on the normalized engagement data, and may generate training labels based on the initial ranking of items.

In some examples, the initial set of items are obtained from a recommendation system, such as item recommendation system 105. Item recommendation system 105 may be a third-party server that provides item recommendations for a given search query. Item ranking computing device 102 may obtain user engagement data for the identified items from database 116, and may then determine an initial ranking of the items as described herein.

Further, item ranking computing device 102 may generate training features based on the historical user session data. The training features may include item-level, query-level, and/or query-item-level based features. The training features may also include derived features, such as a value indicating how much of a text overlap there is between a query and an item title, a value indicating how much a brand name matches with query intent, and others. For example, item ranking computing device 102 may generate feature vectors that identify and characterize item features (e.g., brand, price, item description, item options, etc.), query features (e.g., search terms), item engagement data identifying which items were engaged in response to search results displayed for a search query, and/or derived features.

Item ranking computing device 102 may then train a machine learning model, such as one based on Gradient Boosted Trees, based on the training labels and training features. In some examples, item ranking computing device 102 stores the trained machine learning model within database 116.

In some examples, item ranking computing device 102 generates a hash value based on the stored data characterizing the trained machine learning model. The hash value may be generated based on any known process, such as an MD5 hash. Item ranking computing device 102 may store the hash in database 116. In some examples, item ranking computing device 102 stores the machine learning model within database 116 beginning at a memory location value that is based on the hash value. For example, if a 16 bit hash value is generated (e.g., 0xAB12), item ranking computing device 102 may store the trained machine learning model beginning at a memory location address that includes a base value, and the generated hash value (e.g., 0x44AB1200, assuming a 32 bit memory address).

In some examples, prior to executing the trained machine learning model, item ranking computing device 102 obtains the stored data characterizing the trained machine learning model from database 116, generates a hash value, and compares the generates hash value to the stored hash value. If the hash values match, item ranking computing device 102 determines the trained machine learning model is safe to execute. Otherwise, if the hash values do no match, item ranking computing device 102 generates an error indicating the mismatch. In some examples, the error is displayed on a display.

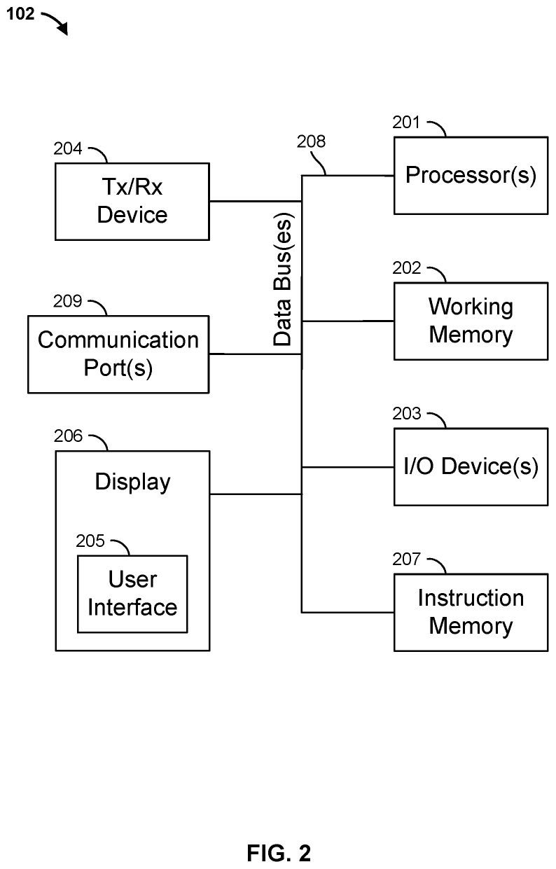

FIG. 2 illustrates the item ranking computing device 102 of FIG. 1. Item ranking computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item ranking computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as machine learning model training data.

Display 206 can display user interface 205. User interfaces 205 can enable user interaction with item ranking computing device 102. For example, user interface 205 can be a user interface for an application of a retailer that allows a customer to view and interact with a retailer's website. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item ranking computing device 102 will be operating in. Processor(s) 201 is operable to receive data from, or send data to, a network, such as communication network 118 of FIG. 1, via transceiver 204.

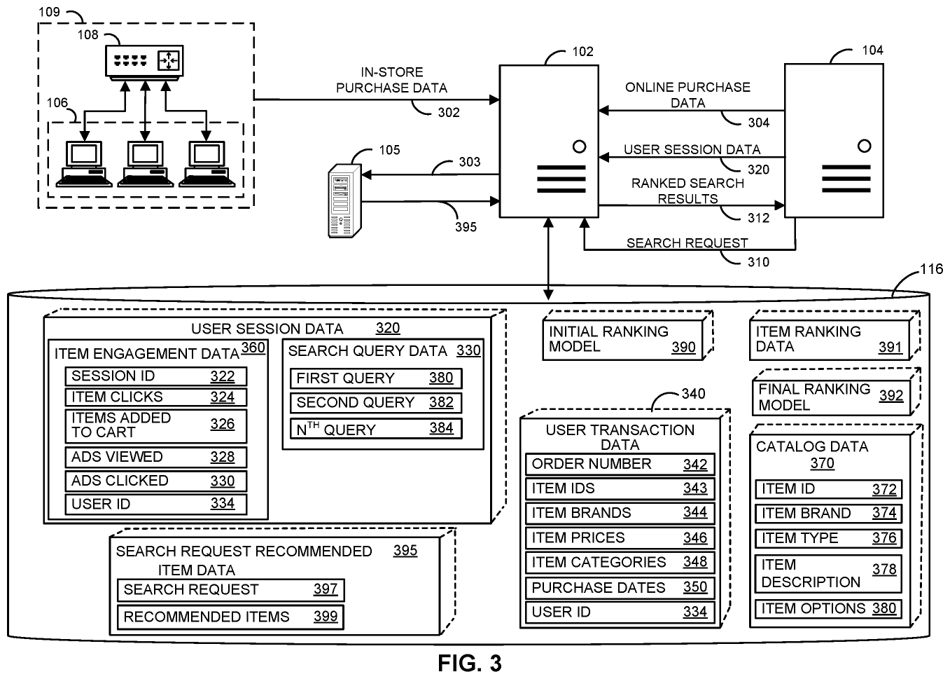

FIG. 3 is a block diagram illustrating examples of various portions of the item ranking system 100 of FIG. 1. As indicated in the figure, item ranking computing device 102 may receive user session data 320 from web server 104, and store user session data 320 in database 116. User session data 320 identifies, for each user, data related to a browsing session, such as when browsing a retailer's webpage hosted by web server 104. In this example, user session data 320 includes item engagement data 360 and search query data 330. Item engagement data 360 includes a session ID 322 (i.e., a website browsing session identifier), item clicks 324 identifying items which the user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 330 identifying advertisements the user clicked on, and user ID 334 ID (e.g., a customer ID, retailer website login ID, etc.). Search query data 330 identifies one or more searches conducted by a user during a browsing session (e.g., a current browsing session). In this example, search query data 330 includes first query 380, second query 382, and N^{th} query 384.

Item ranking computing device 102 may also receive in-store purchase data 302 identifying and characterizing one or more purchases from one or more stores 109. Similarly, item ranking computing device 102 may receive online purchase data 304 from web server 104, which identifies and characterizes one or more online purchases, such as from a retailer's website. Item ranking computing device 102 may parse in-store purchase data 302 and online purchase data 304 to generate user transaction data 340. In this example, user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item category 348 identifying a category of each item purchased, a purchase date 350 identifying the purchase date of the purchase order, and user ID 334 for the user making the corresponding purchase.

Database 116 may further store catalog data 310, which may identify one or more attributes of a plurality of items, such as a portion of or all items a retailer carries. Catalog data 310 may identify, for each of the plurality of items, an item ID 372 (e.g., an SKU number), item brand 374, item type 376 (e.g., grocery item such as milk, clothing item), item description 378 (e.g., a description of the product including product features, such as ingredients, benefits, use or consumption instructions, or any other suitable description), and item options 380 (e.g., item colors, sizes, flavors, etc.).

In some examples, item ranking computing device 102 may receive a search request 310 identifying and characterizing a search query for a user. The search query may include data identifying and characterizing one or more words, for example. Item ranking computing device 102 may apply a trained machine learning model, such as final ranking model 392 stored in database 116, to the search query to generate item ranking values identifying a ranking of items. In some examples, item ranking computing device 102 stores the search query, and the corresponding item rankings, in database 116 as search request recommended item data 395. For example, item ranking computing device 102 may store the search query as search request 397, and may store data identifying the ranked items as recommended items 399. In some examples, item ranking computing device 102 stores the generated ranking values within database 116 as item ranking data 391.

In some examples, to train the machine learning model characterized by final ranking model 392, item ranking computing device 102 applies initial ranking model 390 to normalized engagement metrics, such as query-item pair data identifying a search query and one or more of a CTR, ATR, and OTR for one or more items, to generate an initial ranking of items. In some examples, application of the initial ranking model 390 ranks items based on a descending order of their OTRs. For items with a same order rate, application of the initial ranking model 390 then ranks items in descending order of the ATRs. Further, for items with a same ATR, application of the initial ranking model 390 then ranks items in descending order of the CTRs. In some examples, rather than determining if two or more items have a same metric, item ranking computing device 102 determines if the corresponding metric values are within a threshold amount of each other. If, for example, the metric values are within a threshold amount (e.g., OTRs are within 5% of each other), item ranking computing device 102 ranks them according to the next metric (e.g., ATRs). In some examples, the initial rankings are determined based on a weighting of each of the CTR, ATR, and OTR rates. For example, the items may be ranked according to the following: initial ranking=(w₁*OTR)+(w₂*ATR)+(w₃*CTR).

Item ranking computing device 102 may then generate training labels based on the initial ranking of items for the query. As described herein, item ranking computing device 102 may train a machine learning model, such as one based on Gradient Boosted Trees, based on the generated training labels and training features. Further, item ranking computing device 102 may store the trained machine learning model as final ranking model 392 within database 116.

Item ranking computing device 102 may apply final ranking model 392 to a search query identified by search request 310 and to user session data 320 to generate ranked search results 312 identifying ranking values for one or more items. In some examples, item ranking computing device 102 transmits the search query to item recommendation system 105 within an item request message 303. In response, item recommendation system 105 generates a list of items for the received search query, and transmits the list of items to item ranking computing device 102 as an item response message 395.

Item ranking computing device 102 may transmit ranked search results 312 to web server 104, where ranked search results 312 identifies the ranked set of recommended items. Web server 104 may then display advertisements for the set of recommended items based on the ranking values identified by ranked search results 312.

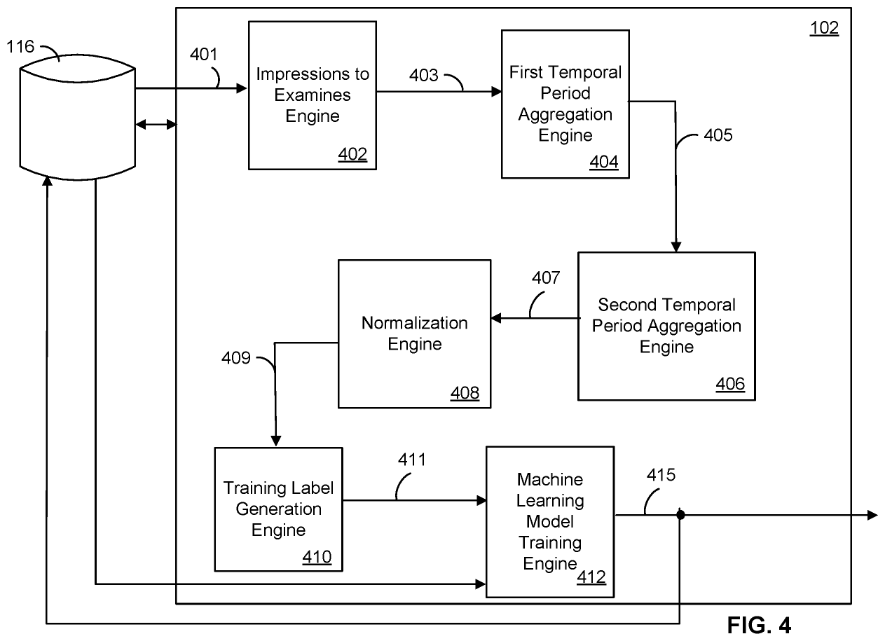

FIG. 4 illustrates further exemplary portions of the item ranking system 100 of FIG. 1 that may be employed to train a machine learning model, such as the final ranking model 392. As indicated in FIG. 4, item ranking computing device 102 includes impressions to examines engine 402, first temporal period aggregation engine 404, second temporal period aggregation engine 406, normalization engine 408, training label generation engine 410, and machine learning model training engine 412.

In some examples, one or more of impressions to examines engine 402, first temporal period aggregation engine 404, second temporal period aggregation engine 406, normalization engine 408, training label generation engine 410, and machine learning model training engine 412 may be implemented in hardware. In some examples, one or more of impressions to examines engine 402, first temporal period aggregation engine 404, second temporal period aggregation engine 406, normalization engine 408, training label generation engine 410, and machine learning model training engine 412 may be implemented as an executable program maintained in a tangible, non-transitory memory, such as instruction memory 207 of FIG. 2, that may be executed by one or processors, such as processor 201 of FIG. 2.

In this example, impressions to examines engine 402 obtains user session data 401 from database 116. For example, impressions to examines engine 402 may obtain, for a temporal period (e.g., such as a one year period, 1 month period, 1 week, etc.), user session data 320. The user session data 401 may include session-level engagement data (e.g., session ID, search query, item ID, impressions, clicks, add-to-cart counts, order counts, etc.). In addition, impressions to examines engine 402 generates item examination data identifying a number of examines for each item corresponding to a search query based on the session-level engagement data. Impressions to examines engine 402 may package an examination message 403 with the session-level engagement data and the item examination data (e.g., vector (session, query, item, examines, item clicks, add-to-cart counts, item order counts), and may provide the examination message 403 to first temporal period aggregation engine 404.

First temporal period aggregation engine 404 may aggregate the session-level engagement data and the item examination data packaged within examination messages 403 within a data repository, such as within database 116. First temporal period aggregation engine 404 may, for example, aggregate the data for each day, week, etc. First temporal period aggregation engine 404 may generate first temporal period query-item pair data 405 characterizing each search query and corresponding item engagement data (e.g., examines, clicks, add-to-cart counts, order counts, etc.) for each corresponding item for the first temporal period, and may provide the first temporal period query-item pair data 405 to second temporal period aggregation engine 406.

Second temporal period aggregation engine 406 may further aggregate the first temporal period query-item pair data 405 for another temporal period, such as a month, quarter, or year, and may generate second temporal period query-item pair data 407 based on the aggregation.

Normalization engine 408 may obtain the second temporal period query-item pair data 407 from second temporal period aggregation engine 406, and may normalize the engagement data based on the corresponding number of examines. For example, normalization engine 408 may perform a normalization using Beta random variables. As an example of using Beta random variables, assume that, for a given query-item pair, historical data aggregated over a month indicates that the item has received 1000 examines and was ordered 30 times in the context of the particular query (e.g., the item appeared in a search result to the query, and was purchased from the search result). If normalization is performed without using Beta random variables, the OTR for this query-item pair may be 30/1000. Using Beta random variables, however, a Beta distribution B(a,b) is generated parametrized by a=30 and b=1000−30, i.e., number of orders as the first parameter a, and number of examines minus the number of orders as the second parameter b. Interestingly, for a Beta random variable that is constructed in this way, the expectation of the random variable is precisely 30/1000. Now, instead of taking the expectation of the random variable as an estimate of the OTR, the 5-percentile point of the distribution is selected, i.e., the point below which lies 5% of the distribution. The value at that point is selected as the value for the OTR. Thus, in this example, the 5-percentile point is selected to be the estimated OTR. A similar computation may be performed for CTR (e.g., using item order events) and ATR (e.g., using item add-to-cart events). In some examples, the percentile point is user selectable (e.g., 0% to 100%, inclusively).

Normalization engine 408 generates initial ranking data 409 characterizing the ranking of items for a search query. For example, normalization engine 408 may apply initial ranking model 390 to the values of ATRs, OTRs, and CTRs to generate the ranking of items. In some examples, normalization engine 408 generates the initial ranking data 409 based on the values of ATRs, OTRs, and CTRs. For example, initial ranking data 409 may include a ranking of items for a query based on sorting the items in a descending order of their OTR. For items with a same OTR, the items are sorted based on their ATR. For items with a same OTR and ATR, the items are sorted based on their CTR. Note that, in this example, the ATRs, OTRs, and CTRs may be normalized based on a corresponding number of examines. Normalization engine 408 provides the initial ranking data 409 to training label generations engine 410.

Training label generations engine 410 generates training labels 411 based on the initial ranking data 409, and provides the training labels 411 to machine learning model training engine 412 to train a machine learning model. Machine learning model training engine 412 further generates training features based on user session data 401 stored in database 116. For example, training label generations engine 410 may generate feature vectors based on item features corresponding to each ranked item identified by initial ranking data 409, and query features based on the corresponding search query for which the initial ranking data 409 was generated. Based on the training labels 411 and the generated training features, machine learning model training engine 412 trains the machine learning model, and provides trained machine learning model 415. In some examples, machine learning model training engine 412 stores the trained machine learning model in database 116. For example, machine learning model training engine 412 may store the trained machine learning model as final ranking model 392.

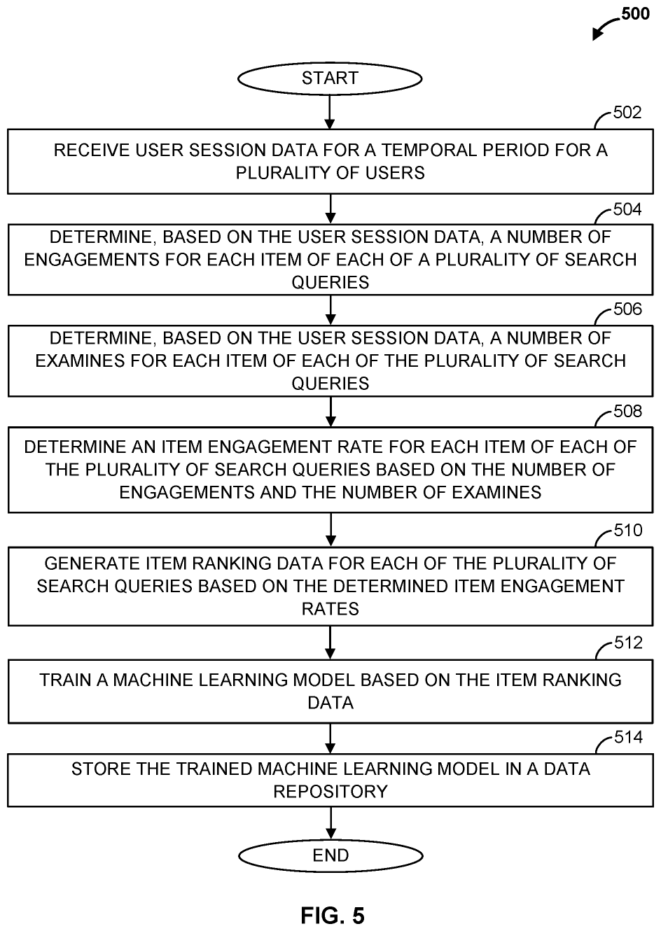

FIG. 5 is a flowchart of an example method 500 that can be carried out by the item ranking system 100 of FIG. 1 to train a machine learning model. Beginning at step 502, a computing device, such as item ranking computing device 102, receives user session data for a temporal period for a plurality of users. For example, item ranking computing device 102 may obtain, from database 116, user session data 320 for a temporal period, such as for the previous month, for each of a plurality of users. The plurality of users may have browsed a website hosted by web server 104, for example. At step 504, the computing device determines, based on the user session data, a number of engagements for each item of each of a plurality of search queries. For example, item ranking computing device 102 may determine, based on item engagement data 360, a number of engagements for the user (e.g., based on item clicks 324, items added to cart 326, ads clicked 330, etc.).

Proceeding to step 506, the computing device determines, based on the user session data, a number of examines for each item of each of the plurality of search queries. For example, item ranking computing device 102 may determine that each item that has been clicked (e.g., item clicks 324, ads clicked 330) has been examined, and further, based on ads viewed 328, that each item appearing before an item that has been clicked, or in some examples, appearing on a same webpage as an item that has been clicked, has also been examined. Item ranking computing device 102 may compute the number of examines, using any of these examples, for each item of each of the plurality of search queries.

At step 508, the computing device determines an item engagement rate for each item of each of the plurality of search queries based on the number of engagements and the number of examines. For example, item ranking computing device 102 may determine an OTR, ATR, and CTR for each item for each of the search queries based on the item engagement data 360 and the computed number of examines for the item. As an example, the computing device may determine the OTR, ATR, and CTR for each query-item pair based on determining a Beta distribution graph using Beta random variables (e.g., B(a,b)), as described herein. In some examples, the computing device receives a selection of the percentile point (e.g., 5%) from a user (e.g., using input-output device 203), and applies the selected percentile point to determine the OTR, ATR, and CTR.

In some examples, the computing device determines the OTR, ATR, and CTR by dividing the number of engagements (e.g., number of times the item was ordered, number of times the number was added to a cart, number of times the item was clicked) by the number of examines for the item (e.g., to determine, respectively, OTR, ATR, and CTR for the item).

At step 510, the computing device generates item ranking data for each of the plurality of search queries based on the determined item engagement rates. For example, item ranking computing device 102 may apply initial ranking model 390 to the values of ATRs, OTRs, and CTRs to generate the ranking of items. As an example, item ranking computing device 102 may rank the corresponding items based on a descending order of their OTR's. For items with a same OTR, item ranking computing device 102 may rank the items based on descending order of their ATRs. Further, for items with a same ATR, item ranking computing device 102 may rank the items based on a descending order of their CTRs.

In some examples, rather than determining if two or more items have a same metric, item ranking computing device 102 determines if the corresponding metric values are within a threshold amount of each other. If, for example, the metric values are within a threshold amount (e.g., OTRs are within 5% of each other), item ranking computing device 102 ranks them according to the next metric (e.g., ATRs). In some examples, the initial rankings are determined based on a weighting of each of the CTR, ATR, and OTR rates.

Further, and at step 512, the computing device trains a machine learning model based on the item ranking data. For example, item ranking computing device 102 may generate training labels based on the rankings, and may train the machine learning model with the generated training labels and generated training features. At step 514, the computing device stores the trained machine learning model in a data repository. For example, item ranking computing device 102 may store the trained machine learning model as final ranking model 392 in database 116. In some examples, the computing device applies the trained ranking model to a received search query to determine a ranking of items for the search query. The method then ends.

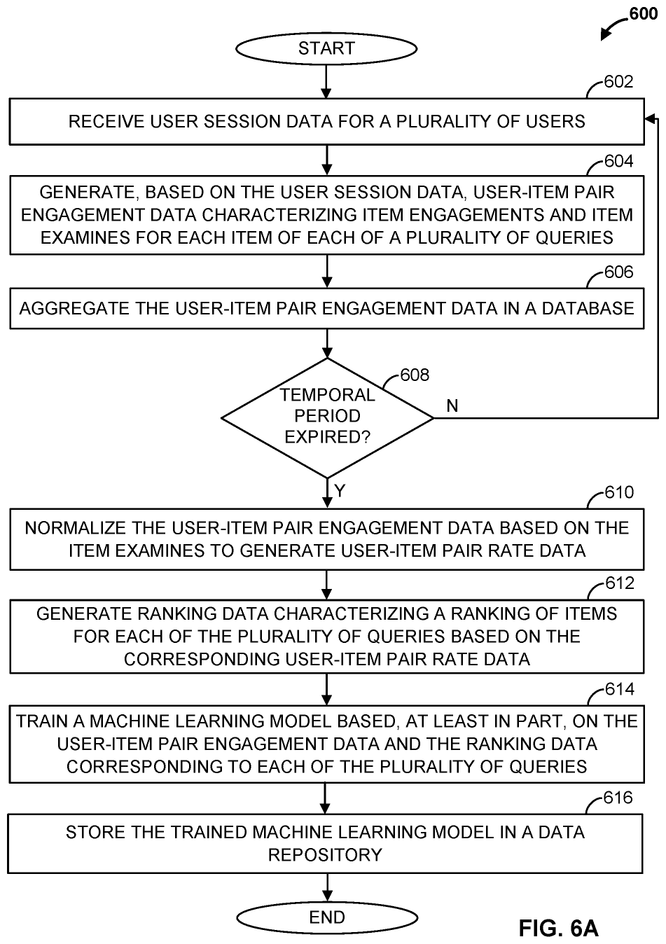

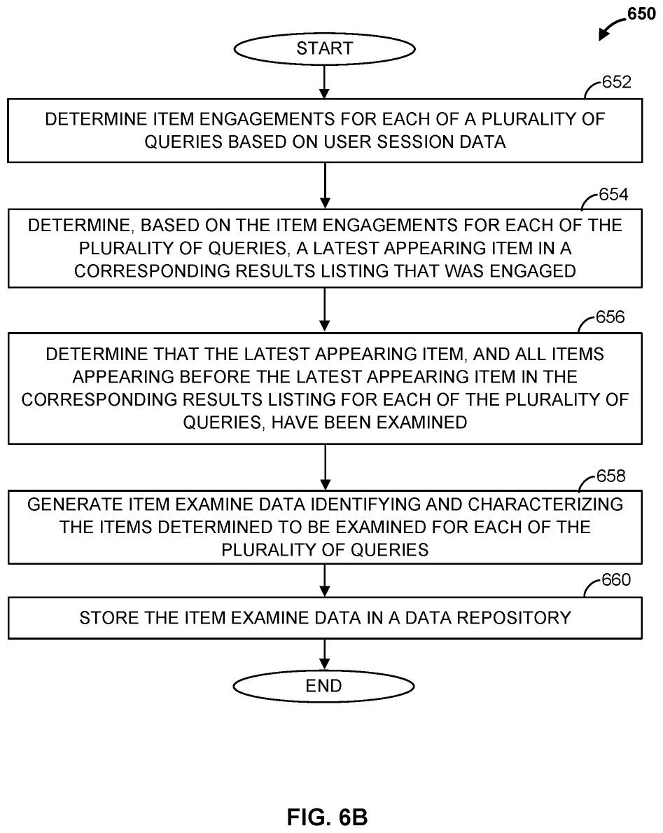

FIG. 6A is a flowchart of an example method 650 that can be carried out by the item ranking system 100 of FIG. 1 to train a machine learning model. Beginning at step 602, a computing device, such as item ranking computing device 102, receives user session data for a temporal period for a plurality of users. For example, item ranking computing device 102 may obtain, from database 116, user session data 320 for a temporal period, such as for the previous month, for each of a plurality of users. The plurality of users may have browsed a website hosted by web server 104, for example.

At step 604, the computing device generates, based on the user session data, user-item pair engagement data characterizing item engagements and item examines for each item of each of a plurality of queries. For example, the user-item pair engagement data may identify query-item pair data that includes corresponding session-level engagement data, item clicks, add-to-cart counts, item order counts, and item examination data (e.g., vector (session, query, item, examines, item clicks, add to carts, orders)). The item examination data, which identifies a number of examines for each item, may be determined in accordance with method 650 of FIG. 6B, for example. Further, and at step 606, the computing device aggregates the user-item pair engagement data in a database, such as within database 116.

Proceeding to step 608, a determination is made as to whether a temporal period has expired. The temporal period may be, for example, a week, a month, a quarter, or any other suitable temporal period. If the temporal period has not expired, the method proceeds back to step 602, where additional user session data is received (e.g., more recent user session data). Otherwise, if the temporal period has expired, the method proceeds to step 610.

At step 610, the computing device generates user-item pair rate data by normalizing the user-item pair engagement data based on the corresponding item examines. For example, item ranking computing device 102 may determine an OTR, ATR, and CTR for each item for each of the search queries based on the item engagement data 360 and the computed number of examines for the item. As an example, the computing device may determine the OTR, ATR, and CTR for each query-item pair based on determining a Beta distribution graph using Beta random variables (e.g., B(a,b)), as described herein. In some examples, the computing device receives a selection of the percentile point (e.g., 5%) from a user (e.g., using input-output device 203), and applies the selected percentile point to determine the OTR, ATR, and CTR.

In some examples, the computing device determines the OTR, ATR, and CTR by dividing the number of engagements (e.g., number of times the item was ordered, number of times the number was added to a cart, number of times the item was clicked) by the number of examines for the item (e.g., to determine, respectively, OTR, ATR, and CTR for the item).

Further, and at step 612, the computing device generates ranking data characterizing a ranking of items for each of the plurality of queries based on the corresponding user-item pair rate data. For example, item ranking computing device 102 may apply initial ranking model 390 to the values of ATRs, OTRs, and CTRs to generate the ranking of items. As an example, item ranking computing device 102 may rank the corresponding items based on a descending order of their OTR's. For items with a same OTR, item ranking computing device 102 may rank the items based on descending order of their ATRs. Further, for items with a same ATR, item ranking computing device 102 may rank the items based on a descending order of their CTRs.

In some examples, rather than determining if two or more items have a same metric, item ranking computing device 102 determines if the corresponding metric values are within a threshold amount of each other. If, for example, the metric values are within a threshold amount (e.g., OTRs are within 5% of each other), item ranking computing device 102 ranks them according to the next metric (e.g., ATRs). In some examples, the initial rankings are determined based on a weighting of each of the CTR, ATR, and OTR rates.

Proceeding to step 614, the computing device trains a machine learning model based, at least in part, on the user-item pair engagement data and the ranking data corresponding to each of the plurality of queries. For example, for each of the plurality of queries, item ranking computing device 102 may generate training labels based on the corresponding ranking data, and may further generate training features based on the corresponding user-item pair engagement data generated at step 604 and aggregated at step 606.

Further, and at step 616, the computing device stores the trained machine learning model in a data repository. For example, item ranking computing device 102 may store the trained machine learning model as final ranking model 392 within database 116. In some examples, the computing device applies the trained ranking model to a received search query to determine a ranking of items for the search query. The method then ends.

FIG. 6B is a flowchart of an example method 650 that can be carried out by the item ranking system 100 of FIG. 1 to determine item examinations. Beginning at step 652, a computing device, such as item ranking computing device 102, determines item engagements for each item corresponding to each of a plurality of queries based on user session data. For example, item ranking computing device 102 may determine, based on item engagement data 360, a number of item clicks, a number of add-to-cart counts, and a number of item order counts for each item corresponding to each of the plurality of queries (e.g., search query data 330).

Further, and at step 654, the computing device determines, based on the item engagements for each of the plurality of queries, a latest appearing item in a corresponding results listing that was engaged. For example, item ranking computing device 102 may determine, out of the engaged items, which item appeared last in search results for the corresponding query.

At step 656, the computing device determines that the latest appearing item out of the items determined to be engaged, and all items appearing before the latest appearing item, in corresponding results listings for each of the plurality of queries, have been examined. Alternatively, in some examples, the computing device determines that each item that has been clicked, and each item that appeared on a same webpage as an item that has been clicked, have been examined.

Proceeding to step 658, the computing device generates item examination data identifying and characterizing the items determined to be examined for each of the plurality of queries. At step 660, the computing device stores the item examination data in a data repository. For example, item ranking computing device 102 may store the item examination data within database 116. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
receive user session data for a plurality of users;
generate, based on the user session data, user engagement data characterizing engagements of one or more corresponding items for each of a plurality of queries;
determine, based on the user session data, a number of examines for each of the one or more corresponding items for each of the plurality of queries;
normalize the user engagement data for each of the one or more corresponding items of each of the plurality of queries based on the corresponding number of examines;
generate ranking data characterizing a ranking of at least a subset of the plurality of items based on the normalized user engagement data;
train a machine learning model based on the ranking data.

2. The system of claim 1, wherein the computing device is configured to:
generate training features based on the user engagement data for each of the one or more corresponding items of each of the plurality of queries; and
generate training labels based on the ranking data;
wherein the machine learning model is trained based on the training features and the training labels.

3. The system of claim 2, wherein the machine learning model is based on Gradient Boosted Trees.

4. The system of claim 1, wherein determining the number of examines comprises determining a number of item clicks, a number of add-to-carts, and a number of item orders for each of the one or more corresponding items.

5. The system of claim 4, wherein normalizing the user engagement data comprises:
generating, for each of the one or more corresponding items for each of the plurality of queries, an order-through rate (OTR), an add-to-cart rate (ATR), and a click-through rate (CTR) based on the corresponding number of item orders, number of add-to-carts, and number of item clicks, respectively.

6. The system of claim 5, wherein generating the OTRs, ATRs, and CTRs comprises:
receiving a selection of a percentile point;
generating a Beta distribution graph for each of the OTRs, ATRs, and CTRs; and
applying the percentile point to select the OTRs, ATRs, and CTRs from the respective Beta distribution graphs.

7. The system of claim 5, wherein generating the ranking data comprises:
determining a descending order of the OTRs for the one or more corresponding items for each of the plurality of queries; and
ranking the at least subset of the plurality of items based on the descending order of the OTRs.

8. The system of claim 7, wherein generating the ranking data comprises:
determining that at least two of the at least subset of the plurality of items have an OTR within a threshold; and
ranking the at least two of the at least subset of the plurality of items based on their corresponding ATRs.

9. The system of claim 1, wherein determining the number of examines for each of the one or more corresponding items for each of the plurality of queries comprises:
determining, based on the user engagement data for each of the one or more corresponding items of each of the plurality of queries, an engaged item appearing last in a search result listing of each of the plurality of queries;
determining any of the one or more corresponding items that appear in the search result listing before the engaged item appearing last; and
determining that the engaged item appearing last and any of the one or more corresponding items that appear in the search result listing before the engaged item appearing last are examined.

10. A method comprising:
receiving user session data for a plurality of users;
generating, based on the user session data, user engagement data characterizing engagements of one or more corresponding items for each of a plurality of queries;
determining, based on the user session data, a number of examines for each of the one or more corresponding items for each of the plurality of queries;
normalizing the user engagement data for each of the one or more corresponding items of each of the plurality of queries based on the corresponding number of examines;
generating ranking data characterizing a ranking of at least a subset of the plurality of items based on the normalized user engagement data;
training a machine learning model based on the ranking data.

11. The method of claim 10, comprising:
generating training features based on the user engagement data for each of the one or more corresponding items of each of the plurality of queries; and
generating training labels based on the ranking data;
wherein the machine learning model is trained based on the training features and the training labels.

12. The method of claim 10, wherein determining the number of examines comprises determining a number of item clicks, a number of add-to-carts, and a number of item orders for each of the one or more corresponding items.

13. The method of claim 12, wherein normalizing the user engagement data comprises:
generating, for each of the one or more corresponding items for each of the plurality of queries, an order-through rate (OTR), an add-to-cart rate (ATR), and a click-through rate (CTR) based on the corresponding number of item orders, number of add-to-carts, and number of item clicks, respectively.

14. The method of claim 13, wherein generating the OTRs, ATRs, and CTRs comprises:
receiving a selection of a percentile point;
generating a Beta distribution graph for each of the OTRs, ATRs, and CTRs; and
applying the percentile point to select the OTRs, ATRs, and CTRs from the respective Beta distribution graphs.

15. The method of claim 10, wherein determining the number of examines for each of the one or more corresponding items for each of the plurality of queries comprises:
determining, based on the user engagement data for each of the one or more corresponding items of each of the plurality of queries, an engaged item appearing last in a search result listing of each of the plurality of queries;
determining any of the one or more corresponding items that appear in the search result listing before the engaged item appearing last; and
determining that the engaged item appearing last and any of the one or more corresponding items that appear in the search result listing before the engaged item appearing last are examined.

16. A non-transitory computer readable medium having instructions stored thereon, wherein the instructions, when executed by at least one processor, cause a device to perform operations comprising:
receiving user session data for a plurality of users;
generating, based on the user session data, user engagement data characterizing engagements of one or more corresponding items for each of a plurality of queries;
determining, based on the user session data, a number of examines for each of the one or more corresponding items for each of the plurality of queries;
normalizing the user engagement data for each of the one or more corresponding items of each of the plurality of queries based on the corresponding number of examines;
generating ranking data characterizing a ranking of at least a subset of the plurality of items based on the normalized user engagement data;
training a machine learning model based on the ranking data.

17. The non-transitory computer readable medium of claim 16, further comprising instructions stored thereon that, when executed by at least one processor, further cause the device to perform operations comprising:
generating training features based on the user engagement data for each of the one or more corresponding items of each of the plurality of queries; and
generating training labels based on the ranking data;
wherein the machine learning model is trained based on the training features and the training labels.

18. The non-transitory computer readable medium of claim 16 wherein:
determining the number of examines comprises determining a number of item clicks, a number of add-to-carts, and a number of item orders for each of the one or more corresponding items; and
normalizing the user engagement data comprises:
generating, for each of the one or more corresponding items for each of the plurality of queries, an order-through rate (OTR), an add-to-cart rate (ATR), and a click-through rate (CTR) based on the corresponding number of item orders, number of add-to-carts, and number of item clicks, respectively.

19. The non-transitory computer readable medium of claim 18, wherein generating the OTRs, ATRs, and CTRs comprises:
receiving a selection of a percentile point;
generating a Beta distribution graph for each of the OTRs, ATRs, and CTRs; and
applying the percentile point to select the OTRs, ATRs, and CTRs from the respective Beta distribution graphs.

20. The non-transitory computer readable medium of claim 16, wherein determining the number of examines for each of the one or more corresponding items for each of the plurality of queries comprises:
determining, based on the user engagement data for each of the one or more corresponding items of each of the plurality of queries, an engaged item appearing last in a search result listing of each of the plurality of queries;
determining any of the one or more corresponding items that appear in the search result listing before the engaged item appearing last; and
determining that the engaged item appearing last and any of the one or more corresponding items that appear in the search result listing before the engaged item appearing last are examined.
